(19) United States
(12) Patent Application Publication
(10) Pub. No.: US 2025/0270771 A1
(43) Pub. Date: Aug. 28, 2025

(54) TAMPING BEAM DEVICE OF A PAVING SCREED, PAVING SCREED, ROAD PAVER AND METHOD FOR CHANGING THE STROKE OF A TAMPING BEAM DEVICE

(71) Applicant: BOMAG GMBH, Boppard (DE)

(72) Inventor: Jürgen HEUSINGER, Boppard (DE)

(21) Appl. No.: 19/050,280

(22) Filed: Feb. 11, 2025

(30) Foreign Application Priority Data
Feb. 26, 2024 (DE) 10 2024 105 304.6

(51) Int. Cl. E01C 19/48; E01C 19/40

(52) U.S. Cl. CPC E01C 19/4853; E01C 19/40

(57) ABSTRACT

A tamping beam device of a paving screed, in particular of a road paver, with a tamping beam, which is arranged on at least one connecting rod, with a drive shaft, which is connected to the connecting rod via an eccentric device. The eccentric device is configured such that a first and a second stroke setting of the tamping beam can be adjusted by means of a thrust member that is axially adjustable on the drive shaft. The thrust member comprises a first region, which is arranged in the eccentric device, and a second region, which is arranged outside the eccentric device. The second region is connected to an axial adjustment device via a thrust bearing. A paving screed and a road paver having such a tamping beam device. A method for changing the stroke of a tamper beam device.

### FIELD

The invention relates to a tamping beam device of a paving screed, a paving screed, a road paver and a method for changing the stroke of a tamping beam device according to the independent claims.

### BACKGROUND

Such tamping beam devices are known in the prior art. In this regard, reference is made, for example, to EP 1 905 899 B1, EP 2 325 391 B1, EP 2 905 378 A1 and DE 10 2015 016 777 A1. Such tamping beam devices are used, especially in road pavers, for pre-compaction and/or post-compaction of the paving material, usually asphalt, during the paving process. The tamping beam devices usually comprise at least one tamping beam, which is arranged on at least one connecting rod, and a drive shaft, which is connected to the connecting rod via an eccentric device and via which the drive movement is introduced into the tamping beam device. The drive shaft can be driven by a hydraulic or electric motor or an upstream driven transmission. The eccentric device converts the orbital movement about the rotation axis of the drive shaft into a tamping movement of the tamping beam. As is often described in the prior art, the eccentric device may comprise a so-called eccentric shaft, the essential feature of which is that it has an eccentric transmission range compared to the rotating shaft. Typical stroke lengths of the tamping beam in a vertical direction, which are obtained via known eccentric devices, are often in the range of 1 mm to 10 mm.

Paving practice has shown that different stroke lengths can be advantageous depending on, for example, the pavement thickness. The above-mentioned documents already partly suggest the possibility that the eccentric device is configured such that a first and a second stroke setting of the tamping beam can be adjusted depending on the direction of rotation of the drive shaft. By switching the direction of rotation of the drive shaft in these embodiments, at least two different stroke lengths of the tamping beam can thus be realized in a simple manner. If, for example, hydraulic or electric motors are used as the drive, the direction of rotation of the drive shaft can be switched easily. However, the switchover is often very abrupt, which can put considerable strain on the material.

Based on the prior art mentioned herein, it is therefore an object of the invention to provide a tamping beam device with which one or more disadvantages of known tamping beam devices can be partially or completely overcome, so that a stroke length adjustment is made possible in an improved manner.

### SUMMARY

The object is achieved with a tamping beam device, a paving screed, a road paver and a method for changing the stroke of a tamping beam device according to the independent claims. Preferred embodiments are cited in the dependent claims.

According to one aspect of the invention, a tamping beam device of a paving screed, in particular of a road paver, with a tamping beam is provided. The tamping beam is arranged on at least one connecting rod. The tamping beam device comprises a drive shaft which is connected to the connecting rod via an eccentric device. The eccentric device is configured such that a first and a second stroke setting of the tamping beam can be adjusted by means of a thrust member that is axially adjustable on the drive shaft. The thrust member has a first region that is arranged in the eccentric device. The thrust member further has a second region that is arranged outside the eccentric device. The second region of the thrust member is connected to an axial adjustment device via a thrust bearing.

A “thrust bearing” according to the present disclosure is to be understood as a bearing that is configured to receive axially acting forces. Axial forces are forces that act in the longitudinal direction of a component, in this case forces that act in axial direction of the drive shaft. In other words, an axial bearing is configured to transmit forces in the direction of a component axis, in this case the drive shaft axis.

An “axial adjustment device” according to the present disclosure is to be understood as a device or apparatus which is configured to effect an axial adjustment of an element which is guided along an axis and is to be adjusted, in this case the thrust member. In particular, the axial adjustment device is configured to bring about the adjustment by means of a linear movement.

Typically, the thrust bearing is located between an adjusting ring mounted on the second region of the thrust member and an actuating element of the axial adjustment device. In particular, the adjusting ring is axially fixed on the second region of the thrust member so that axial forces acting on the adjusting ring are transmitted to the thrust member. The actuating element of the axial adjustment device is used to transfer axial forces to the thrust member via the thrust bearing.

Preferably, a first end of the actuating element, in particular a head end, is configured such that it at least partially engages around the adjusting ring, which is advantageous for force transmission. For example, the head end of the actuating element may be forked. The actuating element can therefore also be referred to as a shift fork. A second end of the actuating element is typically fixed to an axially adjustable rod of the axial adjustment device, with the rod running parallel to the drive shaft. The adjustment movement of the rod can be a linear thrust movement, in particular in a direction of the longitudinal axis of the rod or push rod. Alternatively, a bushing may be arranged on the rod, which is connected to a second end of the actuating element. Typically, the rod is then configured as a spindle shaft and the bushing as a spindle nut, so that the spindle nut can be axially displaced by a rotary movement of the spindle shaft. This improves the torsional rigidity of the connection between the actuating element and the rod, in particular the spindle shaft. To effect the axial adjustment, the axial adjustment device may, for example, have a manual or motorized drive, in particular a spindle drive, which is configured to rotate the rod about its central longitudinal axis or, depending on the embodiment, to displace it axially, whereby an axial adjustment of the thrust member can be effected. For example, an electric, pneumatic or hydraulic motor and/or one or more hydraulic or pneumatic cylinders or an electromagnetic actuator can be used for a motorized drive. A manual drive, for example using a lever mechanism, is also contemplated within the scope of the invention. According to an alternative embodiment, instead of the axially adjustable rod, a shift lever may be provided which is operatively connected to the thrust member in order to provide axial displacement of the thrust member.

The thrust bearing, via which the thrust member is connected to the axial adjustment device, may be provided via one or more bearings. In particular, for example, a first bearing and a second bearing may be provided between the adjusting ring and the actuating element, which are arranged opposite each other, preferably diametrically opposite each other. Preferably, the first bearing and the second bearing are plain bearings, which are formed by plain bearing contact surfaces between the adjusting ring and the actuating element. Typically, the plain bearing contact surfaces of the adjusting ring and the actuating element are made of a plain bearing material, in particular a plain bearing plastic material. According to one example, the adjusting ring consists entirely of a plain bearing material, in particular a plain bearing plastic material (e.g. ultra-high molecular weight polyethylene [PE-UHMW]). Alternatively, it is also possible to form the plain bearing from a plain bearing plastic material in combination with a metal, and thus specifically as a metal-polymer composite plain bearing.

According to a preferred embodiment, a third bearing is provided between the adjusting ring and the actuating element, which is arranged between the first bearing and the second bearing. Typically, the third bearing is a plain bearing, which is configured in a similar way to the first and second plain bearings. The three bearings may also be identical to each other.

A plain bearing may be provided, for example, by an extension of the actuating element that engages in a recess, in particular a groove, of the adjusting ring. In particular, the actuating element may have one or more, especially two or three, extensions that engage in a recess, especially a groove, of the adjusting ring.

According to an alternative embodiment, one or more of the bearings provided between the adjusting ring and the actuating element may be configured as rolling bearings, in particular axial rolling bearings.

In a circumferential direction between the first bearing and the second bearing, a contact-free region is typically provided between the adjusting ring and the actuating element.

According to embodiments described herein, the desired stroke adjustment is achieved by linear displacement of a thrust member along the longitudinal axis of the drive shaft. In particular, it is possible that the eccentric device has a thrust member for this purpose which can be axially adjusted on the drive shaft via an axial adjustment device, the thrust member having a sliding slope on its outer circumferential surface which runs at an angle to the rotation axis of the drive shaft. According to the invention, the linear adjustment movement of the thrust member is used to adjust the eccentricity of the eccentric device.

The thrust member typically has a sliding slope on its outer circumferential surface that runs at an angle to the rotation axis of the drive shaft. The thrust member is therefore an element of the eccentric device that is guided on the drive shaft via the axial adjustment device. To transfer the longitudinal movement of the thrust member into a stroke adjustment of the tamping beam, the thrust member has the sliding slope, which in particular runs at an angle to the rotation axis of the drive shaft. The sliding slope therefore refers to a guide surface along which the eccentric ring is guided, as described in more detail below. Ideally, the sliding slope is arranged on the outer circumferential surface or outer surface of the thrust member. The sliding slope may at least partially or completely extend along the circumference of the thrust member. The inclination of the sliding slope is defined in the direction of the longitudinal extension of the sliding slope, specifically in relation to a virtual reference plane in which the rotation axis of the drive shaft lies. The sliding slope may be straight, although curved or more complex sliding slopes are also within the scope of the invention. A straight course of the sliding slope is advantageous in that it is comparatively easy to produce and also enables reliable operation.

Furthermore, the eccentric device of the tamping beam device according to the invention typically has an eccentric ring which is mounted on the connecting rod. The eccentric ring has a receiving space for the thrust member with a sliding guide running on the sliding slope of the thrust member. One task of the eccentric ring is to generate an eccentricity in interaction with the drive shaft or the eccentric device, which is picked up by the connecting rod and ultimately converted into a tamping movement of the tamping beam. The sliding guide is in this case in contact with the sliding slope of the thrust member. If the thrust member is now adjusted relative to the eccentric ring in axial direction of the drive shaft, the sliding guide slides along the sliding slope, which ultimately results in a radial adjustment and thus an adjustment of the eccentricity of the eccentric ring. This results in a change in the tamper stroke. It will be appreciated that the scope of the invention encompasses embodiments in which the sliding guide and/or the sliding slope have different sizes and/or extensions, in particular in axial direction of the drive shaft. The sliding guide can therefore slide along the sliding slope, which ultimately causes the movement in axial direction of the drive shaft to be converted into a radial adjustment of the eccentric ring. The contact surface between the sliding slope and the sliding guide can be kept relatively small in order to minimize friction, for example. However, in order to enable reliable and, in particular, tilt-free guidance, it is preferred if the sliding slope and the sliding guide have a common contact surface which, viewed in axial direction of the drive shaft, corresponds at least to the adjustment travel of the thrust member and, in particular, is greater than the adjustment travel of the thrust member. The eccentric ring ultimately also connects the connecting rod to the eccentric device and thus indirectly to the drive shaft.

So that a movement range for the thrust member relative to the eccentric ring is possible at all, the eccentric ring is also configured such that it has a receiving space for the thrust member, within which the thrust member can move relative to the eccentric ring along the rotation axis of the drive shaft in the manner described in more detail below. Specifically, the receiving space is thus configured such that the thrust member can be adjusted in axial direction of the drive shaft between a first and a second stop position. When the thrust member is displaced in axial direction of the drive shaft by means of the adjustment device, it changes the eccentricity of the eccentric ring relative to the rotation axis of the drive shaft via the sliding guide and the sliding slope. Eccentricity herein is the distance between the center of the outer circumferential surface of the eccentric ring seen in radial direction and the rotation axis of the drive shaft. Ultimately, when the respective stop position is reached, the thrust member in its first stop position then holds the eccentric ring in the first stroke setting and in its second stop position holds the eccentric ring in its second stroke setting via its sliding slope. The thrust member then typically rotates together with the drive shaft about its rotation axis. The sliding slope is thus configured such that it not only effects the stroke adjustment or the change in the eccentricity of the eccentric ring relative to the drive shaft per se, but also maintains the respective stroke setting of the eccentric ring relative to the drive shaft. The receiving space herein refers to a region within which the thrust member can be axially adjusted along the drive shaft essentially within the eccentric ring.

In terms of interaction, it is therefore preferred if the eccentric device is configured such that an adjustment of the thrust member along the rotation axis of the drive shaft is converted into an adjustment of the eccentric ring in radial direction relative to the rotation axis of the drive shaft. The thrust member in this case forms a spline having a degree of freedom of movement running in the direction of the rotation axis of the drive shaft. If this spline is displaced relative to the eccentric ring in its position on the drive shaft, this results in a forced adjustment of the radial position of the eccentric ring relative to the drive shaft, which ultimately causes the desired stroke adjustment. Since the freedom of movement of the thrust member along the drive shaft is limited by axially spaced stops between which the adjustment range is defined, two defined end positions can be realized by the axially adjustable thrust member coupled with the axial adjustment device. Between the stroke settings at the two end positions, stepless intermediate positions may advantageously be provided according to embodiments described herein. Thus, the stroke of the tamping beam of the tamping beam device described herein can advantageously be adjusted in a stepless manner.

Preferably, the thrust member and the eccentric ring are essentially rotationally locked relative to each other in the direction of rotation of the drive shaft via a guide device and at the same time can be displaced relative to each other along the drive shaft. Rotationally locked should be understood herein to mean that the thrust member is secured against rotation relative to the eccentric ring, particularly within the receiving space of the eccentric ring. This does not mean that there must be no play here. This is even advantageous, for example to enable the necessary longitudinal displacement of the two elements relative to each other. It is important that the thrust member is not arranged freely and rotatably in the eccentric ring and performs a defined adjustment movement relative to the eccentric ring via the guide device. The rotational lock is also advantageous in that it enables reliable transmission of the rotary movement of the drive shaft to the eccentric ring and thus to the connecting rod when the thrust member is in the first or second stop position.

The specific configuration of the guide device may vary. In principle, all axially displaceable shaft-hub connections are suitable, such as spline shaft connections (DIN5461), polygonal shafts (DIN32711), serrated profiles (DIN5481) etc. However, it has proven to be advantageous if the guide device comprises a groove extending in axial direction and an engagement element which engages in the groove, wherein the groove is arranged on the thrust member and the engagement element on the eccentric ring or vice versa. In particular, the engagement element may be a key attached to the thrust member, in particular formed integrally with it, which protrudes beyond the outer surface of the thrust member in radial direction and into the groove on the eccentric ring. Alternatively, the thrust member may also have a recess for a key in the outer surface to provide a corresponding guide.

Generally, it is possible to configure the sliding slope as a projection element or the like. Ideally, however, the sliding slope of the thrust member is formed by the outer surface of the thrust member itself. In this embodiment, the outer surface of the thrust member is therefore almost entirely in contact with the inner surface of the eccentric ring's receiving space. This also ultimately results in particularly reliable guidance of the thrust member relative to the eccentric ring.

Specifically, the outer surface of the thrust member may be cylindrical, in particular in the form of an inclined cylinder. An inclined cylinder is characterized by the fact that its two end faces are parallel to each other but not perpendicular to the outer surface of the cylinder or the cylinder axis. The thrust member is preferably arranged in the eccentric ring such that its cylinder axis intersects the rotation axis of the drive shaft at an acute angle, particularly at an angle of 3° to 15°, especially 5° to 10° and particularly 7° to 9°. The angle is determined in a plane in which both the cylinder axis of the thrust member and the rotation axis of the drive shaft run. In the above-mentioned angle ranges, optimum transmission of the displacement movement of the thrust member along the drive shaft into an adjustment movement of the eccentric ring in radial direction of the drive shaft and a compact design for the desired stroke adjustment range is achieved.

It is preferred if the receiving space of the eccentric ring is configured as a cavity that is essentially complementary to the outer surface of the thrust member. This likewise enables the fullest possible contact between the thrust member and the eccentric ring. Accordingly, the eccentric ring has a hollow-cylindrical receiving space for the thrust member, which is in particular configured as an inclined hollow cylinder. The cylinder axis of this cylindrical cavity ideally runs coaxially to the cylinder axis of the thrust member.

What is important is that the thrust member can be moved along the drive shaft between two defined stop positions within the receiving space. To ensure this, it is preferred to use appropriate stops. The receiving space is therefore ideally limited by stop walls on both sides in axial direction of the drive shaft. These may be partially formed by the eccentric ring itself, although from a design point of view it is preferred if the stop walls are obtained by stop washers that are arranged separately from the eccentric ring. However, it is possible that the stop washers are mounted for co-rotation with the drive shaft and/or with the eccentric ring. Furthermore, the two stops may also serve as vertical guide for the connecting rod. Further, the two stops may serve as a seal for the receiving space so that the lubricant remains in this region and is not thrown out.

To transmit the eccentric rotary movement of the eccentric ring to the connecting rod, it is preferred if the eccentric ring is mounted, towards its outside in radial direction, in a connecting rod bearing so that it can rotate, in particular via a plain or rolling bearing. The eccentric ring can therefore rotate freely about the rotation axis of the drive shaft relative to the connecting rod.

A further aspect of the invention also relates to a paving screed for a road paver with a tamping beam device according to the invention. From a maintenance point of view, it is advantageous if all the tamping beam devices provided on the respective paving screed are configured in accordance with the invention. Generally, however, it is preferred if at least two of the tamping beam devices according to the invention are provided per tamping beam. In this way, a particularly uniform tamping movement can be ensured, especially along the longitudinal extent of the tamping beam. For short tamping beams (e.g. with a total length of 250 mm), a single tamping beam device may be sufficient.

The invention also relates to a road paver with a paving screed according to the invention. The basic functionality of road pavers is generally known in the prior art. The main task of a road paver is to spread, compact and smooth delivered paving material on the underlying ground. Ideally, the tamping beam device according to the invention is driven by a drive source provided on the road paver itself, for example an internal combustion engine. It is particularly preferred if the primary drive, in particular the internal combustion engine, drives a secondary drive, such as a hydraulic motor or an electric motor. The secondary drive then drives, directly or indirectly, the drive shaft of the tamping beam device.

Finally, a further aspect of the invention relates to a method for changing the stroke of a tamping beam device, in particular a tamping beam device according to the invention. The method according to the invention comprises the steps described below.

A) Operating the tamping beam device with a first stroke setting with a rotating drive shaft. The starting point is therefore a first stroke setting. In this state, the tamping beam of the tamping beam device therefore tamps with a first stroke in relation to the vertical direction.

In order to now change the stroke of the tamping beam device, a further step B) comprises adjusting a thrust member on the drive shaft along the rotation axis of the drive shaft via an axial adjustment device, which is connected to the thrust member (20) via a thrust bearing.

By adjusting the thrust member on the drive shaft along the rotation axis of the drive shaft, this results, in a step C), in a conversion of the movement of the thrust member into an adjusting movement of an eccentric ring in radial direction relative to the rotation axis of the drive shaft. This results in a change in the eccentricity of the eccentric ring. This can be achieved, for example, by a straight-wedge mechanism or a comparable device having a sliding slope and a sliding guide. It is therefore essential that the axial movement of the thrust member is used to effect a radial adjustment of the eccentric ring, wherein the thrust member and the eccentric ring are preferably coupled to each other via a transmission or as parts of a transmission. The extent of the adjustment depends, for example, on the gradient of the corresponding transmission slopes and ultimately also on the distance the thrust member moves along the drive shaft.

If, in a step D), the thrust member now strikes against an axial stop, the eccentric ring has reached its second end position.

Subsequently, a step E) comprises operating the tamping beam device with a second stroke setting by transferring the rotary movement of the drive shaft via the thrust member to the eccentric ring. The direction of rotation of the rotating drive shaft in the second stroke setting is identical to the direction of rotation of the rotating drive shaft in the first stroke setting.

It is possible for the thrust member to assume one or more intermediate positions between the first and second end positions. As a result, the method according to the invention can also enable stepless tamper stroke adjustment and setting within the two end positions spaced apart from each other in axial direction.

### BRIEF DESCRIPTION OF THE DRAWINGS

The invention will be explained in more detail below by reference to the embodiment examples shown in the figures; In the schematic figures:

FIG. 1 is a side view of a road paver;

FIG. 2A is an oblique perspective view of a tamping beam device;

FIG. 2B is an oblique perspective view of a drive shaft of the tamping beam device shown in FIG. 2A with an eccentric device;

FIG. 2C is an enlarged detail view of the tamping beam device of FIG. 2A;

FIG. 3 is a cross-sectional view of the tamping beam device of FIG. 2A;

FIG. 4A is an enlarged detail view from FIG. 3 with a large stroke at top dead center; and

FIG. 4B is an enlarged detail view according to FIG. 4A with a small stroke at top dead center.

### DETAILED DESCRIPTION

Like components are designated by like reference numerals in the figures, although recurring components may not necessarily be designated throughout the figures.

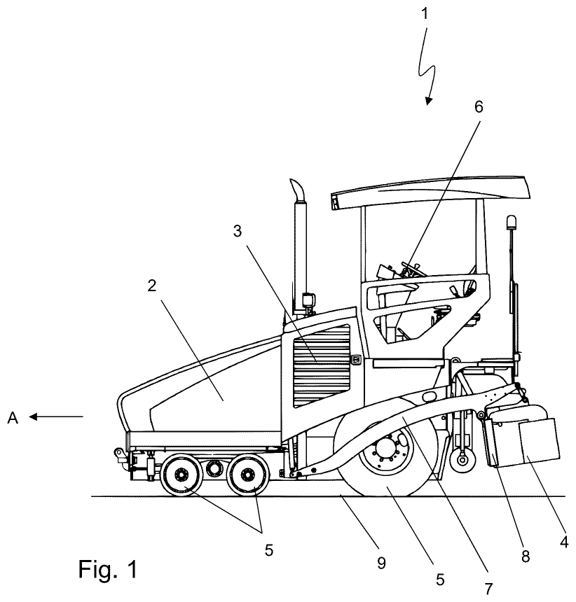

FIG. 1 initially illustrates the basic structure of a typical road paver 1. The main elements of the road paver 1 include a hopper 2, a drive motor 3, a paving screed 4, travel units 5 (wheels and/or crawler tracks) and an operator platform 6. In paving operation, the road paver 1 moves in working direction A over the underlying ground 9. The paving screed 4 is connected to the machine frame (not designated) of the road paver 1 via drawbars 7. In addition to its smoothing function, the paving screed 4 also has a compacting function. For this purpose, a tamping beam device 8 is arranged on the paving screed 4 as an additional device. The other figures relate to the structure and mode of operation of this tamping beam device 8.

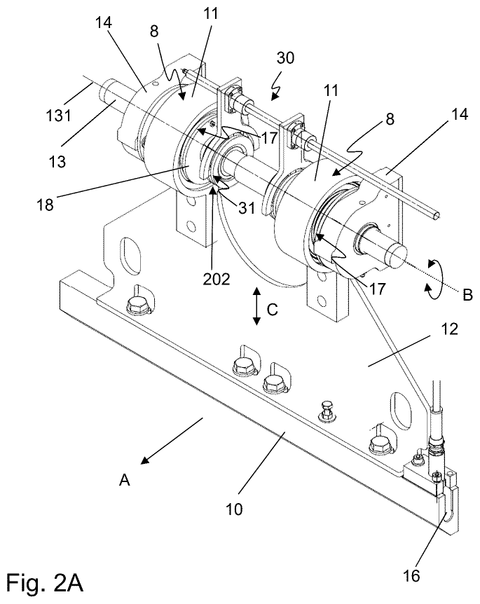

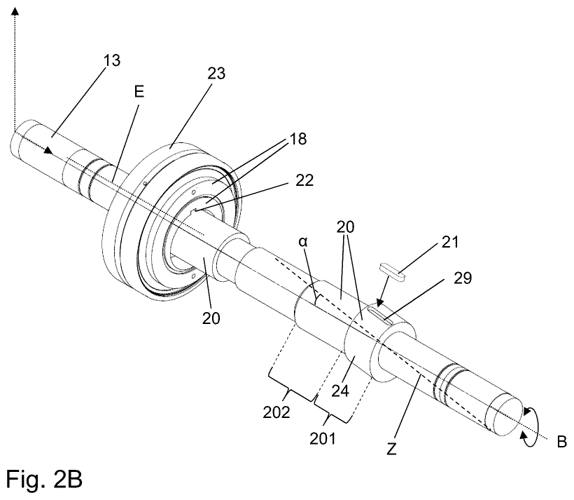

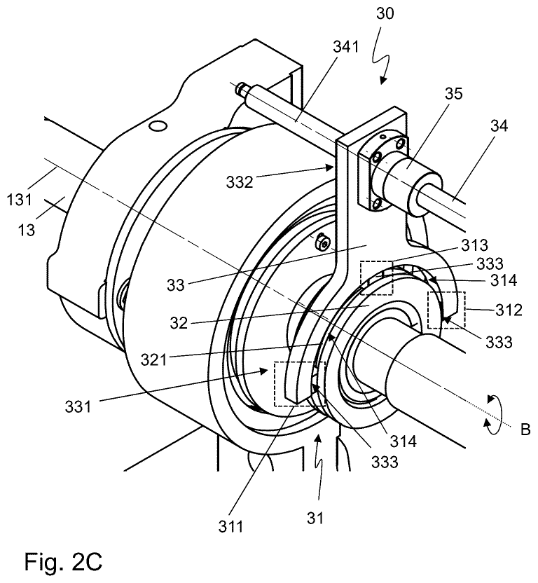

FIG. 2A shows the tamping beam device in its entirety in an oblique perspective front view. In working operation, the tamping beam device 8 is thus guided in working direction A over the pavement to be installed. The tamping beam device 8 typically comprises a tamping beam 10, a connecting rod 11, a connecting plate 12, a drive shaft 13, a holding arm 14 and an eccentric device 17. The tamping beam 10 is usually also heatable by a heating element. This is shown in FIG. 2A through the heating element 16. In the embodiment example shown in FIG. 2A, the tamping beam 10 is mounted on the paving screed by a total of two tamping beam devices 8 via the holding arms 14. The two tamping beam devices 8 have the same functional design. The movement of the tamping beam 10 is a tamping/lifting movement in the direction of the double-headed arrow C. This movement is initiated by the drive shaft 13, which rotates clockwise or counterclockwise in the direction of rotation or orbital direction B about the rotation axis or orbital axis of the drive shaft 13. A corresponding drive device not shown in more detail is provided for this purpose, such as an electric or hydraulic motor or a suitable transmission gearbox.

This centric rotary movement is converted into an eccentric rotary movement using the eccentric device 17 and transmitted to the connecting rod 11. The eccentric crank movement is ultimately converted into the desired tamping movement of the tamping beam 10 via the connecting plate 12. For this purpose, the tamping beam 10 is guided accordingly on the screed 4 (not shown in detail in the figures). Corresponding guides are known in the prior art. Details of the design and operation of the eccentric device 17 are shown in the following figures. In particular, the eccentric device 17 is configured such that the lifting height, i.e., the extent of the tamping/lifting movement in the direction of the double-headed arrow C (i.e., in the vertical direction) can be adjusted in a stepless manner. For this purpose, a thrust member 20 which is axially adjustable on the drive shaft 13 is provided, by means of which a first and a second stroke setting of the tamping beam 10 can be adjusted. Typically, the thrust member 20 is a sleeve that can slide on the outer surface of the drive shaft 13.

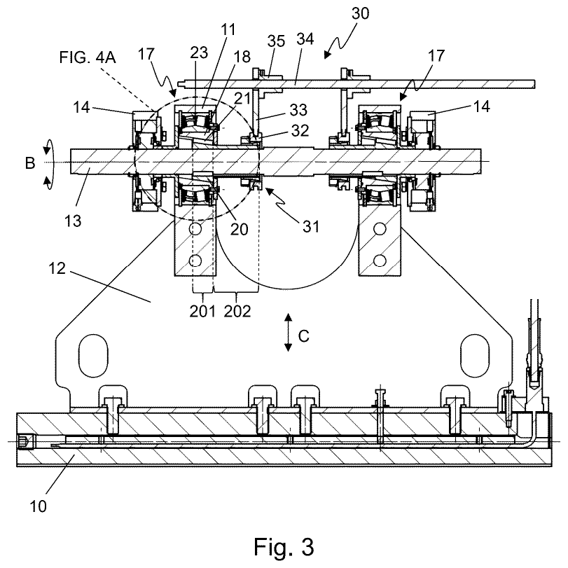

As shown by way of example in FIGS. 2B and 3, the thrust member 20 has a first region 201 and a second region 202. The first region 201 is arranged in the eccentric device 17. The second region 202 is arranged outside the eccentric device 17. The second region 202 is connected to an axial adjustment device 30 via a thrust bearing 31, as shown, for example, in FIGS. 2A, 2C and 3. In particular, the thrust bearing 31 is provided between an adjustment ring 32 mounted on the second region 202 of the thrust member 20 and an actuating element 33 of the axial adjustment device 30. For example, a first end 331 of the actuating element 33 may at least partially engage around the adjusting ring 32, as can be seen in FIG. 2C. The first end 331 of the actuating element 33 may also be referred to as the head or head end of the actuating element 33.

According to one embodiment, which may be combined with other embodiments described herein, at least a first bearing 311 and a second bearing 312 are provided between the adjusting ring 32 and the actuating element (33), as shown by way of example in FIG. 2C. In particular, the first bearing 311 and the second bearing 312 are arranged opposite each other, preferably diametrically opposite each other. Typically, at least one contact-free region 314 between the adjusting ring 32 and the actuating element 33 is provided in the circumferential direction between the first bearing 311 and the second bearing 312. Typically, the first bearing 311 and the second bearing 312 are plain bearings formed by plain bearing contact surfaces between the adjusting ring 32 and the actuating element 33. Typically, at least the plain bearing contact surfaces of the adjusting ring 32 and the actuating element 33 are made of a plain bearing material, in particular a plain bearing plastic material.

As shown by way of example in FIG. 2C, the actuating element 33 may have one or more, in particular two or three, extensions 333. The extensions 333 are typically configured to engage in a recess 321, in particular a groove, of the adjusting ring 32. Typically, the groove is annular and is provided on an outer surface of the adjusting ring 32. The surface of the groove is typically made of a plain bearing material, in particular a plain bearing plastic material. According to one example, the adjusting ring 32 consists entirely of a plain bearing material, in particular a plain bearing plastic material. Further, the extensions 333 of the actuating element 33 are typically made of a plain bearing material, in particular a plain bearing plastic material. According to one example, the entire actuating element 33, or at least the actuating element head, may consist of a plain bearing material, in particular a plain bearing plastic material.

According to one embodiment, which may be combined with other embodiments described herein, a third bearing 313 is provided between the adjusting ring 32 and the actuating element 33, as shown by way of example in FIG. 2C. Typically, the third bearing 313 is arranged between the first bearing 311 and the second bearing 312. Preferably, the third bearing 313 is arranged centrally between the first bearing 311 and the second bearing 312. The third bearing 313 is typically a plain bearing and may be configured analogously to the first and second bearings.

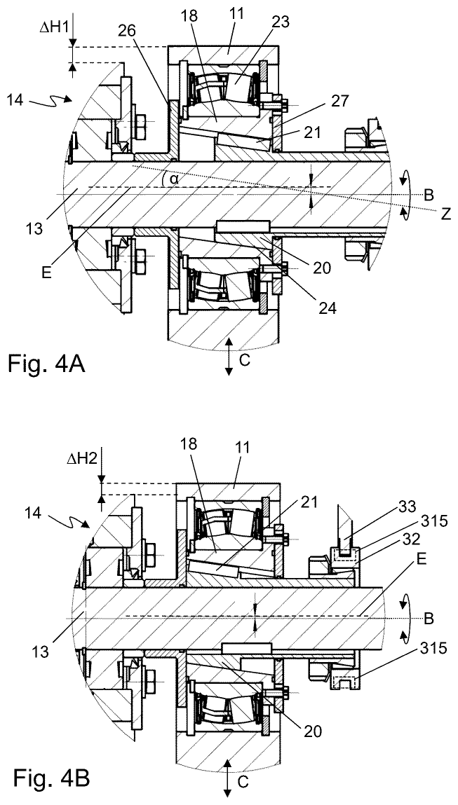

According to an alternative embodiment, the first bearing 311 and/or the second bearing 312 and/or the third bearing 313 may be designed as rolling bearings, in particular axial rolling bearings. This is shown in FIG. 4A as an example for the region between the adjusting ring 32 and the actuating element 33.

As shown by way of example in FIG. 2C, the actuating element 33 is typically fixed to a rod 34 of the axial adjustment device 30. The rod 34 runs essentially parallel to the drive shaft 13. In other words, the rotation axis 131 of the drive shaft 13 and the central longitudinal axis 341 of the rod 34 are parallel to each other. Typically, a bushing 35 is arranged on the rod 34, which is connected to the second end 332 of the actuating element 33. Typically, the rod 44 is configured as a spindle shaft and the bushing 35 as a spindle nut, so that the spindle nut can be axially displaced by a rotary movement of the spindle shaft. Typically, the rod 34 of the adjustment device 30 is connected to a manual or motorized spindle drive, which is configured to rotate the rod 34 about the central longitudinal axis 341, whereby an axial adjustment of the thrust member 20 can be effected.

As can also be seen in FIGS. 2B and 3, the essentially cylindrical thrust member 20 sits at an angle on the drive shaft 13. This means that the inner passage of the thrust member 20, which is complementary to the outer surface of the drive shaft 13, does not run along the cylinder axis Z of the cylindrical outer surface of the thrust member 20, but coaxially to the rotation axis B. As a result, an inclined sliding surface is obtained with the outer surface of the thrust member, which interacts with the eccentric ring 18 in the manner described in more detail below.

FIG. 2B also shows that the thrust member 20 in the present embodiment example may have a receiving recess 29 in the outer surface for a key 21.

When the key 21 is arranged in the receiving recess 29, a projection 21 projecting from the outer surface of the thrust member in the radial direction is provided, which extends longitudinally in the direction of the cylinder axis Z and runs parallel to the latter on the outer surface of the thrust member 20. This projection ensures that the thrust member 20 is secured against rotation relative to the eccentric ring 18. Alternatively, the projection may also be provided as an integral part of the thrust member, i.e., without receiving recess 29 and key 21.

The connecting rod bearing 23 for the connecting rod is shown on the left-hand side in FIG. 2B. FIG. 2B illustrates that the eccentric ring is also a sleeve-shaped component that revolves around the thrust member 20 (relative to the rotation axis B). A guide groove 22 is provided in the eccentric ring 18, in which the projection of the thrust member 20, in particular the key 21, runs. As a result, the thrust member 20 and the eccentric ring 18 co-rotate with each other relative to the rotation axis B of the drive shaft 13. At the same time, however, the thrust member can be adjusted in the axial direction of the rotation axis B and thus displaced relative to the eccentric ring 20 in this direction. For this purpose, the length of the corresponding guide groove in the axial direction B is longer than the total extension of the projection. Due to the inclination of the outer surface of the thrust member 20 relative to the rotation axis B of the drive shaft, the eccentricity of the outer surface of the eccentric ring 18 is adjusted by such a longitudinal movement of the thrust member 20. In other words, the position of the contact surface between these two elements 18 and 20 changes as a result of the thrust adjustment of the thrust member 20 relative to the eccentric ring 18, so that a different eccentricity is achieved. This will be explained in more detail using the cross-sectional views below. The eccentric rotation of the eccentric ring 18 is transmitted to the connecting rod 11, which surrounds the eccentric ring on its outer surface. The existing eccentricity E is indicated in FIGS. 4A and 4B by the position of the cylinder axis Z in relation to the outer surface of the eccentric ring 18 or the connecting rod bearing 11, which is also annular.

FIG. 3 shows the embodiment example according to FIG. 2A in a cross-sectional view in a vertical plane along the rotation axis B of the drive shaft 13, and FIG. 4A shows an enlarged detail view of the framed region. FIGS. 3 and 4a illustrate first of all that, due to the configuration of the thrust member 20 and the eccentric ring 18 described above, a longitudinal movement of the thrust member 20 causes a radial adjustment of the eccentric ring 18 relative to the drive shaft 13. The inclined arrangement of the cylindrical surface of the thrust member 20 ultimately results in a sliding slope 24 on the thrust member 20. The eccentric ring rests against this sliding slope 24 with a correspondingly configured sliding guide, which corresponds to its inner surface. If the relative position of the thrust member 20 is now adjusted along the rotation axis B of the drive shaft 13 relative to the eccentric ring 18, the eccentric ring 18 slides along the sliding slope 24 of the thrust member 20 and is thus raised or lowered relative to the rotation axis B. This adjustment movement is driven by the axial adjustment device 30, which is connected to the thrust member 20 via the thrust bearing 31. FIG. 4A shows that the adjustment movement of the thrust member 20 can take place between the stops 26 and 27, which limit and seal the movement space or receiving space 28 within the eccentric ring 18 for the thrust member 20 in the axial direction of the rotation axis B on both sides.

FIGS. 4A and 4B relate to the two maximum possible stroke settings in the present embodiment example. FIGS. 4A and 4B each show a cross-sectional view through the eccentric device 17, in each case at a time when the connecting rod 11 or the eccentric device 17 has reached its top dead center. If the thrust member 20 is moved to the right on the drive shaft in this embodiment example and strikes against the stop 27 there, the distance in the horizontal plane, for example to the upper edge of the bracket 14, is ΔH1 (this large stroke corresponds to twice the vertical distance between E and B in FIG. 4a). A rotary movement of the drive shaft 13 results in the eccentric ring 18 performing an eccentric rotary movement and thus causing the connecting rod 11 and ultimately the tamping beam not shown in FIG. 4A to perform the tamping movement. The position of the eccentric ring axis E, i.e., the axis that forms the central axis of the outer circumferential surface of the eccentric ring, is also shown in FIG. 4A for more detailed illustration. It can be clearly seen that this axis is parallel but not coaxial to the rotation axis B of the drive shaft 13.

If the thrust member 20 is displaced to the left on the drive shaft in the present embodiment example, as shown by way of example in FIG. 4B, and strikes against the stop 26 there, the distance in the horizontal plane, for example to the upper edge of the bracket 14, is ΔH2. If the thrust member 20 is displaced from right to left, the eccentric ring slides along its sliding guide on the sliding slope of the thrust member 20 and its central axis Z approaches the rotation axis B of the drive shaft 13. This continues until the movement of the thrust member 20 along the drive shaft 13 is stopped by the stop 26. If the drive shaft 13 is rotated in the position shown in FIG. 4B, the eccentric ring 18 rotates about the drive shaft 13 with the reduced stroke ΔH2.

A possible alternative embodiment also encompassed by the invention consists, for example, in connecting the actuating element 33 shown in FIG. 3 firmly to the rod 34 and displacing the rod 34 linearly in axial direction to achieve an axial adjustment. Instead of a rotational adjustment movement of the rod 34, in this case the rod 34 is thus moved axially or preferably parallel to the direction of rotation B. The spindle nut 35 and the configuration of the rod 34 as a threaded rod are then not required.

The rotational or linear adjustment movement of the rod 34 may be driven by a motor, for example by an electric, pneumatic or hydraulic motor, by means of a suitable actuator, for example a pneumatic or hydraulic cylinder or an electromagnetic actuator, or also manually, for example by means of a hand crank and/or a suitable lever mechanism. The rod 34 may also be configured as a toothed rack, for example. In particular, the corresponding drive device may be operatively connected to the rod 34 at at least one or both of its axial ends.

As can be seen from the embodiments described herein, a tamping beam device is advantageously provided which enables stroke adjustment in an improved manner. The option of stepless adjustment is particularly advantageous. Furthermore, a stroke adjustment is made possible in which material loads during the adjustment process can be reduced compared to solutions known from the prior art.

### LIST OF REFERENCE NUMERALS

1 road paver
2 hopper
3 drive motor
4 paving screed
5 travel units
6 operator platform
7 drawbars
8 tamping beam device
9 underlying ground
10 tamping beam
11 connecting rod
12 connecting plate
13 drive shaft
131 rotation axis of the drive shaft
14 holding arm
15 center region
17 eccentric device
18 eccentric ring
20 thrust member
201 first region of the thrust member
202 second region of the thrust member
21 projection/key
22 guide groove
23 connecting rod bearing
24 sliding slope
26 stop
27 stop
29 receiving recess
30 axial adjustment device
31 thrust bearing
311 first bearing
312 second bearing
313 third bearing
314 contact-free region
315 rolling bearing
32 adjusting ring
321 recess/annular groove
33 actuating element
331 first end of the actuating element
332 second end of the actuating element
333 extensions
34 rod
341 central axis of the rod
35 bushing
A working direction
B direction of rotation
C tamping/lifting movement

What is claimed is:

1. A tamping beam device of a paving screed, in particular of a road paver, with a tamping beam which is arranged on at least one connecting rod, with a drive shaft which is connected to the connecting rod via an eccentric device, wherein the eccentric device is configured such that a first and a second stroke setting of the tamping beam can be set by means of a thrust member which is axially adjustable on the drive shaft, wherein:
the thrust member comprises a first region, which is arranged in the eccentric device, and a second region, which is arranged outside the eccentric device, the second region being connected to an axial adjustment device via a thrust bearing.

2. The tamping beam device according to claim 1, wherein the thrust bearing is provided between an adjusting ring mounted on the second region of the thrust member and an actuating element of the axial adjustment device.

3. The tamping beam device according to claim 2, wherein a first end, in particular a head, of the actuating element at least partially engages around the adjusting ring.

4. The tamping beam device according to claim 2, wherein a first bearing and a second bearing are provided between the adjusting ring and the actuating element, in particular wherein the first bearing and the second bearing are arranged opposite each other, preferably diametrically opposite each other, and wherein a contact-free region between the adjusting ring and the actuating element is provided in the circumferential direction between the first bearing and the second bearing.

5. The tamping beam device according to claim 4, wherein the first bearing and the second bearing are plain bearings formed by plain bearing contact surfaces between the adjusting ring and the actuating element.

6. The tamping beam device according to claim 5, wherein at least the plain bearing contact surfaces of the adjusting ring and of the actuating element consist of a plain bearing material, in particular a plain bearing plastic material, in particular wherein the adjusting ring consists entirely of a plain bearing material, in particular a plain bearing plastic material.

7. The tamping beam device according to claim 4, wherein a third bearing is provided between the adjusting ring and the actuating element, which is arranged between the first bearing and the second bearing, in particular wherein the third bearing is a plain bearing.

8. The tamping beam device according to claim 2, wherein the actuating element has one or more, in particular two or three, extensions which engage in a recess, in particular a groove, of the adjusting ring.

9. The tamping beam device according to claim 2, wherein the first bearing and the second bearing are rolling bearings.

10. The tamping beam device according to claim 2, wherein the actuating element is fixed to a rod of the axial adjustment device, wherein the rod runs essentially parallel to the drive shaft.

11. The tamping beam device according to claim 10, wherein a bushing is arranged on the rod, which bushing is connected to a second end of the actuating element.

12. The tamping beam device according to claim 1, wherein the axial adjustment device has a manual or motorized drive, in particular a spindle drive, for axial adjustment.

13. A paving screed for a road paver with a tamping beam device according to claim 1.

14. The paving screed according to claim 13, wherein it comprises a tamping beam which is supported and driven via at least two of the tamping beam devices.

15. A road paver with a paving screed according to claim 13.

16. A method for changing the stroke of a tamping beam device according to claim 1, comprising the steps of:
a) operating the tamping beam device with a first stroke setting with a rotating drive shaft;
b) adjusting a thrust member on the drive shaft along the rotation axis of the drive shaft via an axial adjustment device, which is connected to the thrust member via a thrust bearing;
c) converting the movement of the thrust member along the drive shaft into an adjustment movement of an eccentric ring in radial direction relative to the rotation axis of the drive shaft;
d) striking of the thrust member against an axial stop; and
e) operating the tamping beam device with a second stroke setting by transmitting the rotary movement of the drive shaft via the thrust member to the eccentric ring, wherein the direction of rotation of the rotating drive shaft in the second stroke setting is identical to the direction of rotation of the rotating drive shaft in the first stroke setting.
